(19) United States
(12) Patent Application Publication
(10) Pub. No.: US 2016/0292664 A1
(43) Pub. Date: Oct. 6, 2016

(54) METHOD OF ORDERING BASED ON ESTIMATED TIME OF ARRIVAL

(71) Applicant: Christopher James GILFOYLE, Nova Scotia (CA)

(72) Inventor: Christopher James GILFOYLE, Nova Scotia (CA)

(21) Appl. No.: 14/392,150

(22) PCT Filed: Jun. 26, 2014
(86) PCT No.: PCT/CA2014/000522

§ 371 Date: Dec. 23, 2015

(30) Foreign Application Priority Data
Jun. 26, 2013 (CA) 2820432

(51) Int. Cl. G06Q 20/32; H04W 4/02

(52) U.S. Cl. CPC G06Q 20/3224; H04W 4/027

(57) ABSTRACT

A method for prioritizing a transmitted order based upon a customer's estimated time of arrival comprises the steps of: transmitting an order to a vendor by a customer via a localization-capable device; identifying the location of the customer via the localization-capable device; calculating the estimated time of arrival of the customer at the vendor based upon the customer's location; and placing the order in a queue with the vendor. The queue is arranged according to such criteria as the anticipated completion time of pending orders, and the anticipated completion time of the customer's order corresponds to the customer's estimated time of arrival at the vendor. While on route to the vendor, a new location of the customer via the localization-capable device is identified and an updated estimated time of arrival of the customer at the vendor is calculated based upon the customer's new location. Thereafter the position of the order in the queue based upon the updated estimated time of arrival is adjusted and the order is completed in relation to the updated estimated time of arrival.

### FIELD OF THE INVENTION

The present invention relates to a method of ordering products from a vendor by which the product is prepared and made available to the customer based on the customer's estimated time of arrival (ETA) at the vendor's location. The present invention also relates to a system to perform the method.

### BACKGROUND OF THE INVENTION

Two popular methods of ordering a product, such as fast food, include in-store service at a cashier, and utilization of a drive-through window.

An in-store service is provided by a business that allows customers to enter the vendor's store to purchase products. Orders are generally placed by waiting to speak to a sales representative, such as a cashier, and when the product is ready, it is made available to the customer. A First In First Out (FIFO) method is used where the ordering in-store generally follows the following steps (see FIG. 1):
a) Customer enters place of business, and may be required to wait to place order;
b) Customer places order with sales representative;
c) Customer pays for order;
d) Customer waits for ordered product to be prepared; and
e) Customer receives order.

A drive-through is a type of service provided by a vendor that allows customers to purchase and receive products without requiring them to leave their cars and enter the place of business. Orders are generally placed by the customer using a microphone or intercom system and the product is obtained from a sales representative often through a window at the place of business.

A drive-through system generally consists of: 1) a speaker and microphone for customers to place their orders; 2) a speaker and microphone or wireless headset system for sales representative to receive the customer's order; 3) a trigger pad beneath the concrete of the driveway to detect a customer's car and activate the microphone and headset, possibly augmented with a CCTV camera; 4) one or more free-standing signs listing the menu items, such as a menu board (newer drive-throughs feature a LCD or LED display within the speaker system in order to show the full order and total cost to avert order errors through miscommunication); and 5) one or more windows in the place of business enabling employees to interact with customers while they are in their vehicles. The method of ordering via a drive-through generally follows the following steps (see FIG. 2):
a) Customer arrives in vehicle at place of business, proceeds into the drive-through lane and waits to advance to order area;
b) Customer communicates with sales representative and places order at order menu;
c) Customer advances in drive-through lane to the payment window and pays for order;
d) Customer waits for ordered product to be prepared; and
e) Customer advances in drive-through lane to the pickup window and receives order.

As can be seen from the above-described methods of ordering a product, in both scenarios the customer is often required to wait to order a product with the sales representative, and then is often required to wait further while the product is being prepared and/or packaged.

When the vendor receives multiple orders from different customers, the orders are addressed in chronological sequence, with priority given to the earliest order. This is known as a first-in-first-out (FIFO) operation of orders. It would be beneficial to provide a method that minimizes or eliminates the cumulated waiting time a customer faces in the ordering process.

There have been attempts in the prior art to improve upon the first-in-first-out method of placing orders.

United States Patent Application publication No. 2012/0209657 (Connolly) teaches an automated location based customer detection and ordering system. The system determines the proximity of a customer to a merchant and initiates an ordering mechanism for common routine purchases, such as coffee, bagels, and donuts. An electronic device, such as a smartphone, corresponds to the customer and indicates the customer's presence within proximity of a particular merchant. A central repository receives the proximity indication of a customer and a registered merchant, and sends a confirmation request for the predetermined service offering. Upon customer confirmation or order modification, the repository sends a confirmed order request to the merchant for preparation and delivery on customer arrival. A GPS device can be used to determine the customer's proximity.

U.S. Pat. No. 7,359,868 and publication No. 2008/0195505 (Kirkpatrick) teaches a method and system for processing a remote order that allows a customer to remotely send a signal to a business. The signal contains the order information for the customer and what the customer wants from the business. Thus, this system allows the business to process such an order before the customer arrives at the business, preventing idle time by the customer at the business while the order is being processed.

U.S. Pat. Nos. 6,880,750, 7,234,640 and 8,123,130 (Pentel) teaches a remote ordering device for placing orders through cell phones or other wireless devices. A data receiving station receives the data, processes the orders and keeps track of accounts, inventory and retains other data as required. The receiving station can provide instructions to a person or machine to fill orders at any desired location. The instructions may be printed out or displayed on a screen. A GPS, WAP or other location finding system, may be used to identify the user's location. Bioelectronics, Caller I.D, pin numbers or other identification means can be used to verify the user for debiting accounts or credit cards. Users can remotely order tickets, meals, services, or control machines remotely and either arrange for pick up at a desired location or for delivery.

U.S. Pat. No. 8,204,757 (Carlson et al.) teaches a computer program for creating a dynamic food order for a traveler. A food order is received from the traveler. A determination is made as to whether a real-time itinerary for the traveler has changed. In response to a change in the real-time itinerary, the food order is adjusted based on the real-time itinerary and preferences stored in the traveler's profile to form an adjusted food order.

U.S. Pat. No. 6,940,393 and publication 2006/0006025 (Dev et al.) teaches a system and method of queuing orders relative to a pickup location such that a customer who places an order after a customer who placed an earlier order can be signalled to approach a pickup location before the first customer if the order of the second customer is ready before the order of the first customer. The system can signal a customer to wait in a predefined location until the order is ready, or the system can signal the customer to approach the pickup location.

U.S. Pat. Nos. 7,895,797 and 7,992,355 (Bridgman et al.) teaches a vehicular drive-thru food ordering and delivering system and method. The system includes a lot, a drive-thru lane and a building for receiving and filling drive-thru orders. The building has a primary food delivery window for passing ready orders to drive-thru customers, and a downstream in-line parking area for drive-thru vehicles having a delayed order.

A PizzaPizza.ca iPhone™ application allows a customer to place food orders via their iPhone. The customer can choose pickup or delivery, and the PizzaPizza™ location can be chosen by their proximity to the closest location as determined by GPS. The customer can choose the estimated time for pickup or delivery and payment method.

A Seamless.com™ smartphone application allows a customer to place food orders to a variety of restaurants via their smartphone. The customer can choose pickup or delivery, and the GPS function locates nearby restaurants for the customer to choose from. The customer can choose the estimated time for pickup or delivery and payment method.

A Domino's Pizza™ smartphone application allows a customer to place food orders via their smartphone. The customer can choose pickup or delivery, and the Domino's location can be chosen by their proximity to the closest location as determined by GPS. The application has a “Domino's Tracker” feature to provide an ETA of your order, it allows the customer to follow their order from the “make line”, to the oven, then out for delivery or ready to be picked up. The customer can alternately choose the estimated time for pickup or delivery and also choose payment method.

The present invention was made in recognition of the above-identified art and with a view to provide a method of ordering products from a vendor that would be prepared and ready for pick up based on the customer's estimated time of arrival at the vendor's pickup location.

### SUMMARY OF THE INVENTION

It is therefore an object of the present invention to provide an estimated time of arrival based ordering method and associated system.

According to an aspect of the present invention, there is provided a method for prioritizing a transmitted order based upon a customer's estimated time of arrival, comprising the steps of: transmitting an order to a vendor by a customer via a localization-capable device; identifying a location of the customer via the localization-capable device; calculating the estimated time of arrival of the customer to the vendor based upon the customer's location; placing the order in a queue with the vendor, wherein the queue is arranged according to such criteria as anticipated completion time of pending orders, and the anticipated completion time of the customer's order is the customer's estimated time of arrival at the vendor; identifying a new location of the customer via the localization-capable device; calculating an updated estimated time of arrival of the customer at the vendor based upon the customer's new location; adjusting the position of the order in the queue based upon the updated estimated time of arrival; completing the order at about the updated estimated time of arrival.

Preferably, the customer's order is placed in the queue along with a plurality of other orders placed by other customers. The other orders may also be remotely placed orders via localization-capable devices, but may be locally placed, such as at the vendor's place of business.

According to one embodiment, the new location and/or ETA of the customer is identified at predetermined intervals, such as every five minutes, every minute, every thirty seconds etc., thereby providing up to date location tracking of the customer. The frequent location tracking of the customer allows the estimated time of arrival of the customer to be correspondingly adjusted, which may either raise or lower the priority position of the customer's order in the queue.

According to another embodiment, a transmission of the new location and/or ETA of the customer to the vendor is only made if the new location and/or ETA differs more than a predetermined amount form the originally calculated ETA.

According to a further aspect of the present invention, there is provided a system for prioritizing a transmitted order based upon a customer's estimated time of arrival, the system comprising: an order entry device for placing an order from a user; a server for receiving and processing an order from the user; and communication means between the order entry device and the server; wherein the order entry device comprises self-localization capabilities for transmission of location and/or estimated time of arrival at a vendor.

### BRIEF DESCRIPTION OF THE DRAWINGS

Embodiments of the present invention will be further described, by way of example, with reference to the accompanying drawings, in which:

FIG. 1 shows a flow chart of a prior art first-in-first-out in-store method of ordering a product from a vendor;

FIG. 2 shows a flow chart of a prior art first-in-first-out drive-through method of ordering a product from a vendor;

FIG. 3 shows a flow chart of an estimated time of arrival based method of ordering a product from a vendor according to an embodiment of the present invention; and

FIG. 4 shows a flow chart of an estimated time of arrival based ordering method for renting a car at e.g. an airport according to an embodiment of the present invention.

### DETAILED DESCRIPTION OF THE INVENTION

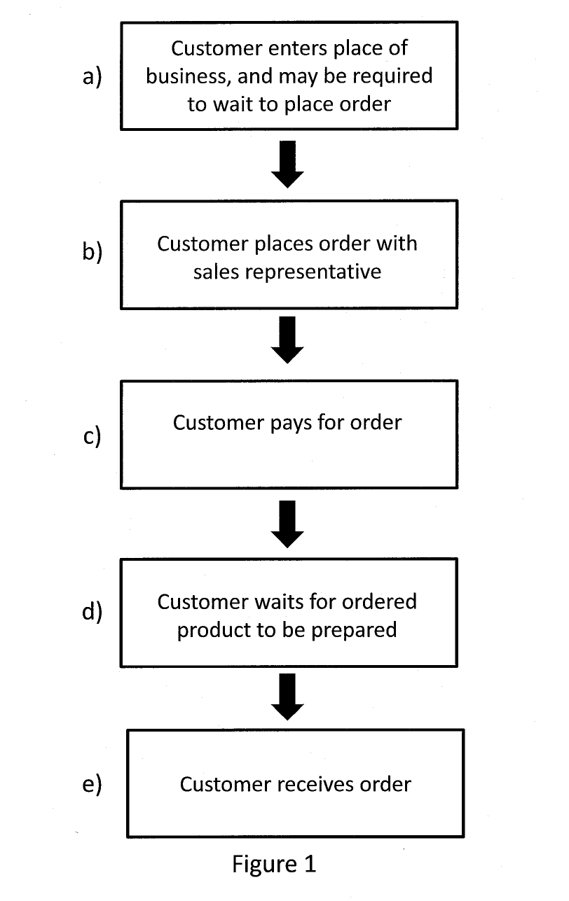

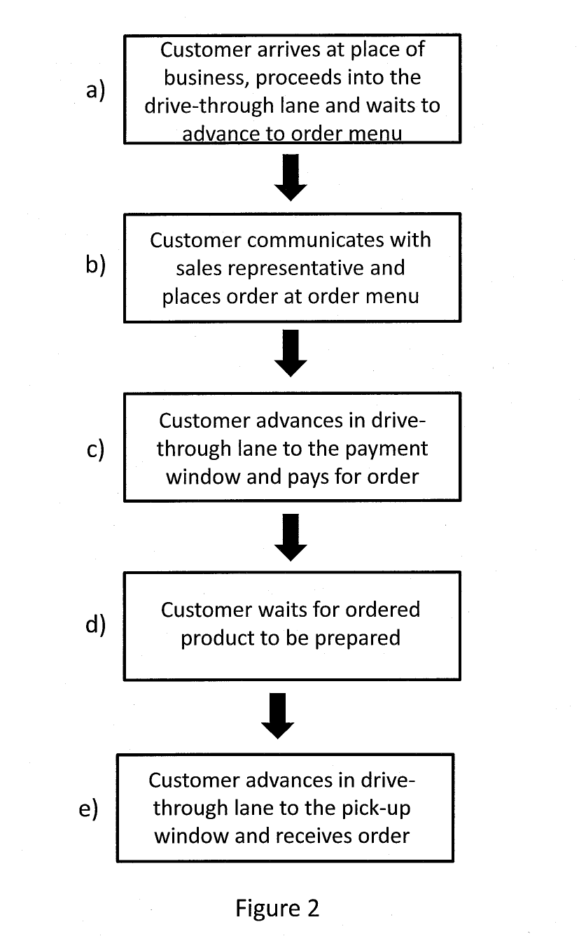

FIGS. 1 and 2 illustrate known first-in-first-out methods of ordering products from a vendor, as discussed above.

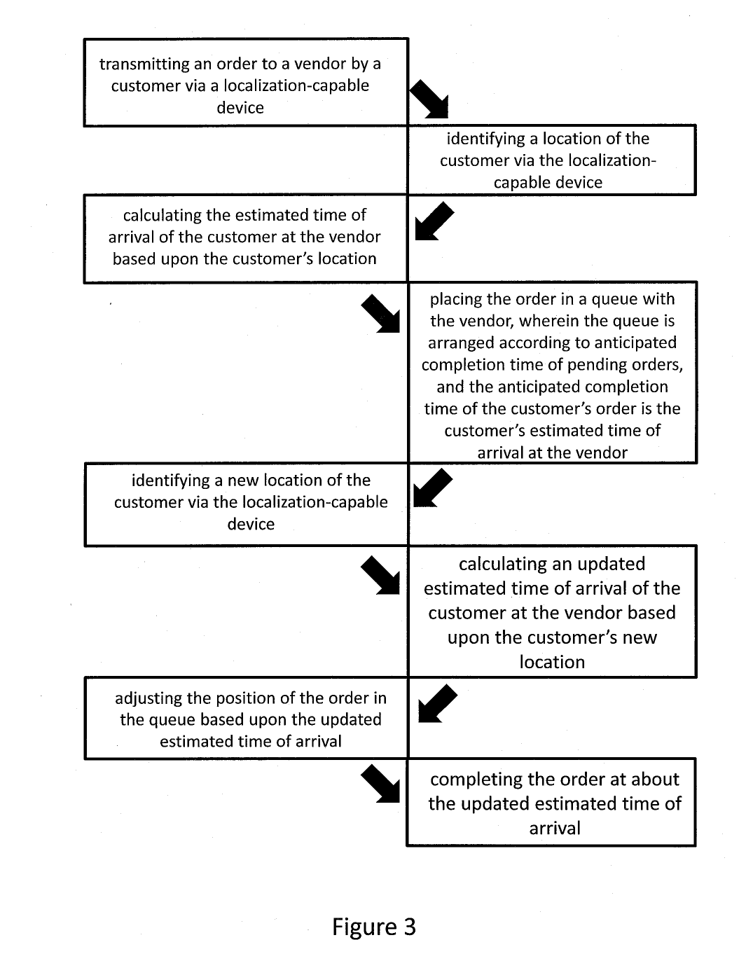

FIG. 3 shows a flow chart of an ETA based ordering method according to an embodiment of the present invention. The order may be transmitted directly to a receiver and associated computer system at a vendor's place of business. Once the desired product is ordered, the ultimate preparation by the vendor and subsequent in-store pickup of the ordered product by the customer is primarily dictated by the real-time estimated time of arrival of the customer. According to this embodiment, the basic method comprises the following exemplary steps:
a) transmitting an order to a vendor by a customer via a localization-capable device;
b) identifying a location of the customer via the localization-capable device;
c) calculating the ETA of the customer to the vendor based upon the customer's location;
d) placing the order in a queue with the vendor, wherein the queue is arranged according to such criteria as anticipated completion time of pending orders, and the anticipated completion time of the customer's order is the customer's ETA to the vendor;
e) identifying a new location of the customer via the localization-capable device;
f) calculating an updated ETA of the customer at the vendor based upon the customer's new location;
g) adjusting the position of the order in the queue based upon the updated ETA;
h) completing the order at about the updated ETA.

In this embodiment of the present invention, a consumer places an order to a vendor via a device, such as a computer program on a computer or laptop, a website, an application (app) on a smartphone/Iphone™, tablet or a similar device. The device preferably has localization capabilities, such as global positioning system (GPS) capabilities or other known mobile tracking capabilities.

In addition to the order, the location of the customer is also transmitted to the vendor. Once the order and customer location is received by the vendor, a vendor data processing system calculates as ETA for the customer. In another embodiment, the customer device calculates the ETA based upon customer location and transmits the ETA and/or the customer location to the vendor with the order. The ETA for the customer is based upon the geographic location of the customer at the time of placing the order, and the physical location of the vendor's place of business. Other factors, such as current traffic levels and transit speeds may also be taken into consideration when calculating ETA.

The vendor data processing system generates a queue of all pending orders, where the orders are prioritized according to certain criteria. The queue facilitates processing of orders. The queue preferably is made available to the staff of the vendor through, e.g. a graphical user interface (GUI), in order to provide structure and guidance concerning the priority of pending orders. In one embodiment, the queue is arranged chronologically, and may be sorted and prioritized by a variety of criteria, such as time the order is placed, estimated time of order completion or time that the vendor should start fulfilling the order. Additional information may also be contained in and used to sort and prioritize the queue, such as time to complete the order and client ETA.

Upon receipt of the order and the customer's location and/or ETA, the order is initially placed within the queue according to certain criteria. See exemplary Table 1 below.

TABLE 1

| | | Time To | | Order | |
|---|---|---|---|---|---|
| | Time of | Complete | Client | Start | Estimate Time of |
| Client | Order | Order | ETA | Time | Order Completion |
| 1 | 5:00 | 7 minutes | 0 | 5:00 | 5:07 |
| 3 | 4:58 | 11 minutes | 0 | 4:58 | 5:09 |
| 2 | 4:58 | 4 minutes | 5:09 | 5:05 | 5:09 |
| 6 | 4:59 | 10 minutes | 5:05 | 4:59 | 5:09 |
| 4 | 4:57 | 6 minutes | 5:13 | 5:07 | 5:13 |
| 5 | 4:55 | 9 minutes | 5:20 | 5:11 | 5:20 |

Table 1 illustrates an exemplary snapshot of a queue at e.g. 5:00. The table is ordered according to estimated time of order completion, but may also be ordered according to other criteria, such as Order Start Time, to conveniently alerts the vendor when staff should initiate filling an order. Clients 1 and 3 are have physically placed their order at the vendor's place of business, and are waiting for the vendor to fulfill their orders. Clients 2, 4, 5 and 6 have placed their orders remotely according to an embodiment of the present invention, and are on route to the vendor's place of business to collect their orders. Although clients 2, 4 and 5 placed their orders earlier than clients 1 and 3, due to the calculated ETA for the remote clients, their orders do not automatically receive a higher priority in the order queue. The vendor is then able to expeditiously fulfill orders based upon anticipated arrival time of customers, rather than on when the order is initially placed. The ETA of client 6 precedes the anticipated order completion time, even if the order is processed immediately. In such a scenario, client 6 will be required to wait at the vendor's place of business, and may be directed to a waiting area.

In the Example presented in Table 1, if these orders were placed with a vendor operating a standard FIFO system, i.e. a system were orders are filled as soon as the order is placed, the Estimated Time of Order Completion for Clients 1 to 6 would be: 5:07, 4:48, 5:09, 4:56, 5:04 and 5:09, respectively. In multiple cases, the order would unnecessarily be prepared before the client would be available to pick it up.

Prioritization of orders based upon client ETA according to the present invention also can alleviate any congestion that may accumulate when multiple orders are placed at or near the same time. In a FIFO system, all six orders from Table 1 would preferably be started within a five minute window, which may cause confusion amongst the workers. Whereas the prioritization of the orders according to the present invention stretches that window to thirteen minutes.

After a remote customer places an order with the vendor, as the customer travels to the vendor's place of business to pick up the order, subsequent locations of the customer are identified by the localization-capable device. Based upon the new location of the customer at a given time point, an updated ETA of the customer to the vendor's place of business is calculated by e.g. the customer's device for transmission to the vendor, or by the vendor's data processing system based upon a transmitted new location of the customer. This updated ETA can be used to alter the priority of the customer's order in the queue, thereby maintaining the queue in an optimal order relative to the ETA of the customers.

The updated ETA may be about the same as the initial ETA, in which case, there may be no impact on the customer's priority order in the queue, dependent upon potential changes in any other pending orders. However, the updated ETA may project the customer to arrive at the vendor's place of business at an earlier or later time than the original ETA, which may positively or negatively alter the priority position of the customer's order in the queue. The vendor's queue is then updated to reflect any changes. See exemplary Table 2.

TABLE 2

| | | Time To | | Order | |
|---|---|---|---|---|---|
| | Time of | Complete | Client | Start | Estimate Time of |
| Client | Order | Order | ETA | Time | Order Completion |
| 1 | 5:00 | 7 minutes | 0 | 5:00 | 5:07 |
| 3 | 4:58 | 11 minutes | 0 | 4:58 | 5:09 |
| 6 | 4:59 | 10 minutes | 5:05 | 4:59 | 5:09 |
| 4 | 4:57 | 6 minutes | 5:13 | 5:07 | 5:13 |
| 2 | 4:58 | 4 minutes | 5:15 | 5:11 | 5:15 |
| 5 | 4:55 | 9 minutes | 5:20 | 5:11 | 5:20 |

Table 2 illustrates the queue of Table 1 at e.g. 5:03, where client 2 has been delayed on route to the vendor. This delay was detected through the transmission of updated location information and/or calculated ETA to the vendor for client 2, and is reflected in the adjusted ETA of the customer. Accordingly, the order start time and estimated time of order completion have been adjusted, and the customer's position within the queue has been altered. The result is that barring any adjustment in the ETA of client 4, the vendor will now undertake fulfilling the order for client 4 before client 2.

In one embodiment, the identification and subsequent transmission of the new locations and/or ETAs of the customer to the vendor may be performed randomly, such as whenever the location and/or ETA of the customer changes while on route, or may be performed at predetermined time intervals, such as every two minutes, thirty seconds or even continuously in real time. Higher frequency of the location and/or ETA update transmissions will produce a more accurate representation of the customer ETA.

In another embodiment, the identification of the new locations and/or calculation of updated ETAs of the customer occurs e.g. randomly, when the location of the customer changes while on route to the vendor, or at predetermined time intervals. However, transmission of these new locations and/or ETAs of the customer to the vendor only occur if the updated ETAs cause the original ETA, i.e. the ETA established for the customer upon placing the order, to change more than a predetermined interval. Such a predetermined interval may be set by the vendor, and may comprise any interval of time, such as thirty seconds, one minute, etc.

For example, the vendor may establish that only transmissions that alter the original ETA at least one minute in either direction should be received. In such a scenario, if the customer has an updated ETA of a delay of thirty seconds while on route to the vendor, this updated ETA would not be transmitted to the vendor, and therefore, this delay would not be reflected in an updated prioritization of the customer's order in the queue. If the customer experiences further delays on route, culminating in an adjusted delay of ninety seconds total, this adjusted ETA would be transmitted to the vendor, as it attains the exemplary threshold established by the vendor of one minute. The priority of the order in the queue may then be altered to reflect this updated ETA.

Receiving updates of a new customer location and/or ETA and subsequent refreshing of the queue to reflect the current location of the customer may occur up until the customer arrives at the vendor's place of business. However, once the vendor has commenced fulfilling the order for the customer, any alterations in the ETA of the customer may no longer be necessary. Accordingly, in one embodiment, once preparation of the customer order commences, the system discontinues receiving transmissions from the customer's device about the location and/or ETA of the customer. This may require the vendor to indicate to the system that preparation of the customer order has begun, or the system may automatically discontinue receiving transmissions from the customer or refreshing the queue once the recommended order start time has been reached. The system may then alert the customer, via the customer's device, that preparation of the order has begun.

In one embodiment, the customer's ordering device receives and displays information pertaining to the order to alert the customer of its ongoing status. For example, upon placing an order with a vendor, the vendor system transmits an acknowledgement of the order to the customer's device, which may include additional information such as an order identification number, confirmation of initial ETA of the customer to the vendor's place of business, anticipated completion time of the order based upon the original ETA, confirmation of pickup location, time interval for transmission of adjusted location/ETA as established by the vendor or any additional information relevant to the order.

According to another embodiment, the information transmitted to the customer's device from the vendor's system, such as customer's location and/or ETA, status of the order, and anticipated completion time of the order, will update during the transit of the customer to the vendor's place of business. Optionally, the customer device will have access to the vendor's queue of orders, which will allow the customer to monitor where their respective order is prioritized in relation to other orders, and to monitor when fulfillment of the order has begun and anticipated completion time.

According to one embodiment, once a customer transmits an order through the device, the default position of the system is that the customer is directly travelling to the vendor's place of business. Therefore, transmission of the customer's location and/or ETA to the vendor, followed by any subsequent required adjustment of the customer's order in the queue, commences upon placement of the order. However, in another embodiment, the customer will have the option of inputting a specific time of arrival in the future, which may be required if, for example, the customer will not be travelling directly to the vendor's place of business. Such a scenario may arise if the customer has additional tasks to complete before attending the vendor's place of business. In such a scenario, the initial position of the customer's order in the queue is the customer's inputted estimated time of arrival. In this embodiment, the customer will be prompted to indicate on the ordering device once they are travelling to the vendor's place of business. At this point, transmission of the customer's updated location and/or ETA to the vendor, followed by any subsequent required adjustment of the customer's order in the queue, commences upon customer confirmation that they are on route to the vendor's place of business.

If the vendor has multiple locations within a certain area, or even worldwide, according to one embodiment, the device can recommend the nearest location to the customer at the time of placing the order. The customer would have the option to confirm the recommended location. The customer will optionally have the ability to choose any vendor location within the area, surrounding areas or elsewhere, with which to place the intended order. Confirmation of the selected vendor location is optionally provided to the customer.

According to one embodiment, the order, location and/or calculated ETA and any subsequent updated information may be transmitted directly to the system located with the specified vendor. Alternatively, in the case of e.g. a franchised business with multiple locations, the order, location and/or calculated ETA and any subsequent updated information may be transmitted to a central data processing system, e.g. at a franchise headquarters, that thereafter transmits said information to a system located at the relevant vendor's place of business.

Optionally, when placing the order through the device, the customer may indicate that payment will be made when the customer arrives at the vendor's location to receive the order. This may be done by any standard payment means. Alternatively, the customer may choose to pay and financially complete the transaction when placing the order. From the vendor's perspective, it may be preferred for the customer to provide payment through the ordering device at the time of placing the order, such as by credit card, debit card, or other known electronic money transfer or banking methods, including Interac™ and Paypal™. Requiring payment at the time of ordering may minimize the instance of customers placing orders and then, inadvertently or otherwise, not continuing on to the place of business to pickup their product. Such delinquent orders will waste resources and reduce the intended efficiency of the system.

Prepayment of orders will also reduce customer wait time upon arrival at the vendor's location. Confirmation of payment is preferably transmitted to the customer's ordering device.

The described method is applicable to vendors offering both drive-through and traditional in-store pick-up models. Vendors employing the ordering method of the present invention may choose to install dedicated drive-through lanes and/or windows, or counters, cashiers and/or waiting areas inside the place of business, purposed to increase efficiency of the customer to obtain their order, once they arrive at the vendor's place of business. This would circumvent waiting for new customers who are placing their orders via traditional methods.

Furthermore, it is contemplated that the method of the present invention would be suitable to a plurality of industries. Preferably, these businesses require that an order be placed, such as for a product, followed by subsequent pick up of the order by the customer. Accordingly, for the purpose of this invention, vendor refers to any business that sells, rents, leases or otherwise makes available to the public wares or services. Non-limiting example include restaurants, such as fast-food restaurants, pizza restaurants and coffee shops, for the ordering and pickup of food and/or beverages. Other service industries may also benefit from such a system, such as car rental places, home improvement stores for the pickup of lumber, rental tools ets., and electronics stores.

Elementary schools and child daycare facilities are also contemplated, as the system of the present invention would alert the facility as to the ETA of the parent or guardian, allowing for clean-up and preparation of the child for pick-up. Similarly, the method of the present invention could be applied to pet grooming businesses.

The system associated with carrying out the methods described herein above comprises an ordering device, such as a smartphone, tablet, computer etc. It is preferred that the customer ordering device has localization capabilities, such as global positioning system (GPS) capabilities or other known tracking capabilities. Also included is vendor equipment, such as a central data processing computer, and a communication channel connecting the user equipment the vendor equipment, such as the internet and/or a cell network and/or wifi. The user ordering device is configured to allow a user to place an order with a vendor via the vendor equipment through a communication channel and to provide updates to the vendor on the location and/or ETA of the customer to the vendor's location. The vendor equipment is configured to receive remote orders from the customer via the ordering device through the communication channel and to provide the vendor with updated location and/or ETA information of the customer. The system may also include a separate pickup location for orders placed via the estimated time of arrival method of ordering. Additionally, the vendor's place of business may comprise a separate waiting area.

### Examples

An example of how the methods of the present invention will address efficiency and minimize delays is described herein below. In the scenario below, customers 1 to 4 each have the same order, and preparation time for each separate order is 3 minutes:

### Time and Method of Orders:

Customer 1 leaves home by car and orders at 19:45 and has an ETA of 19:59 and has prepaid for his order via the ordering device;
Customer 2 leaves home by bus and order at 19:20 and has an ETA of 20:00 and has chosen to pay at pickup via near field communication (NFC) phone swipe;
Customer 3 orders in-store at 19:55 and has paid in line; and
Customer 4 orders in-store at 19:58 and has paid in line.

### Original Order Queue and Pickup Timing Order:

Time queue of orders: Customer 2, Customer 1, Customer 3, Customer 4;
Time of preparation for each order begins at: 19:55 (Customer 3), 19:56 (Customer 1), 19:57 (Customer 2), 19:58 (Customer 4);
Time that orders are picked up: Customer 3 @ 19:58, Customer 1 @ 19:59, Customer 2 @ 20:00, Customer 4 @ 20:01.

As can be seen in the preceding example, overall productivity has increased and wait times for the customer have been minimized. In the case of the food service industry, the freshness of the product may also be maximized. The time between customer order and pickup may have increased for Customers 1 and 2 but time waiting in line at the vendor's store decreased as product preparation was carried out while customer was en route. Employee time can also be redirected and refocused toward filling orders.

Below is a modified version of the above example, where Customer 1 is delayed to the place of business on route. The ordering device has transmitted the relevant location and/or ETA to the vendor, and the queue has been adjusted accordingly, thereby allowing the employees to address orders that now are assigned with a higher priority.

Adjusted order queue and pickup timing when Customer 1 is delayed on route:
Time queue of orders: Customer 2, Customer 1, Customer 3, Customer 4;
Time of preparation for each order begins at: 19:55 (Customer 3), 19:57 (Customer 2), 19:58 (Customer 4), 20:02 (Customer 1);
Time that orders are picked up: Customer 3 @ 19:58, Customer 2 @ 20:00, Customer 4 @ 20:01, Customer 1 @ 20:05.

With fewer employees taking orders/payment, they can be delegated for product preparation/delivery. There is a reduction in space requirement for waiting vehicles. The projection of arrival time and items ordered reduces the amount of products waiting after production. Reduction of time in a drive-through line reduces fuel waste.

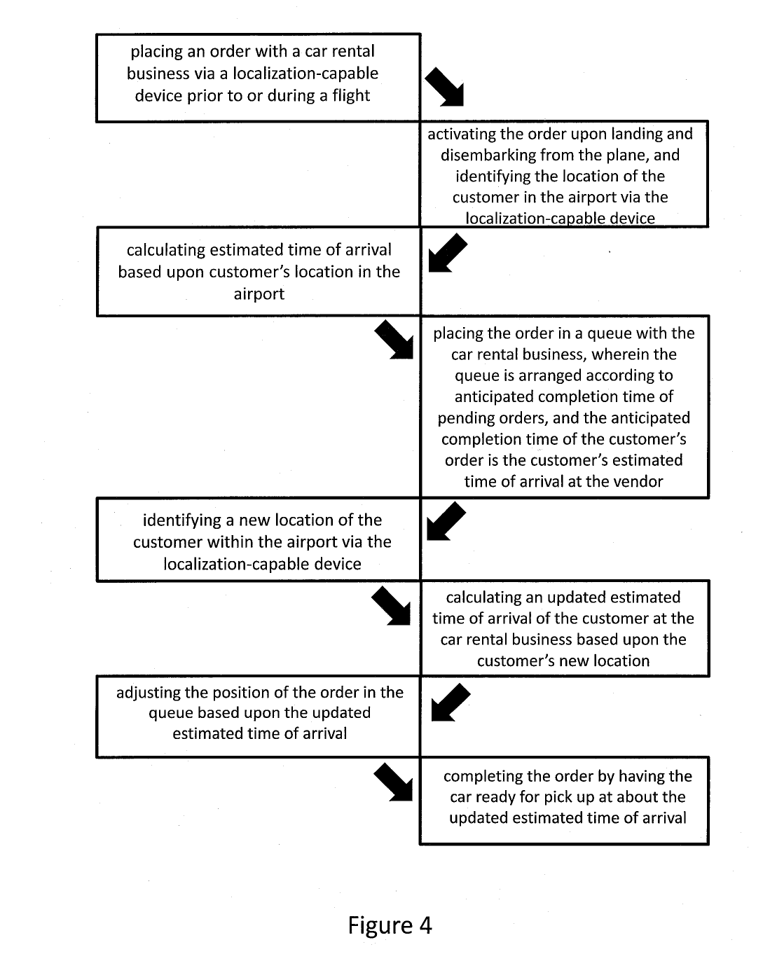

The estimated time of arrival based ordering method can also be applied to products such as car rentals. FIG. 4 shows a flow chart of an estimated time of arrival based ordering method for renting a car at an airport according to an embodiment of the present invention. The improved method for ordering takes into account the estimated time of arrival of a customer who placed their order via a computer program, website, or “app” on a smartphone or a similar localization-capable device. The customer orders would be interspersed with the traditionally made first-in-first-out orders to maximize efficiency and minimize delays. According to this embodiment, the basic method comprises the following steps:
a) placing an order with a car rental business via a localization-capable device prior to or during a flight;
b) activating the order upon landing and disembarking from the plane, and identifying the location of the customer in the airport via the localization-capable device;
c) calculating estimated time of arrival based upon customer's location in the airport
d) placing the order in a queue with the car rental business, wherein the queue is arranged according to anticipated completion time of pending orders, and the anticipated completion time of the customer's order is the customer's estimated time of arrival at the vendor;
e) identifying a new location of the customer within the airport via the localization-capable device;
f) calculating an updated estimated time of arrival of the customer at the car rental business based upon the customer's new location;
g) adjusting the position of the order in the queue based upon the updated estimated time of arrival;
h) completing the order by having the car ready for pick up at about the updated estimated time of arrival.

Optionally, during the process the customer may review and confirm rental agreement. The customer may also be informed if the car rental pickup counter is busy, or what car options are available. If possible, the customer may forward a photograph of the required documents to (license, passport, etc.) through the ordering device to the vendor in order to streamline the process.

The foregoing is an exemplary embodiment of the present invention and a person skilled in the art would appreciate that modifications to these embodiments may be made without departing from the scope and spirit of the invention.

1. A method for prioritizing a transmitted order based upon a customer's estimated time of arrival, comprising the steps of:
a) transmitting an order to a vendor by a customer via a localization-capable device;
b) identifying a first location of the customer via the localization-capable device;
c) calculating the original estimated time of arrival of the customer to the vendor based upon the customer's location;
d) placing the order in a queue with the vendor based upon the original estimated time of arrival;
e) identifying a second location of the customer via the localization-capable device;
f) calculating an updated estimated time of arrival of the customer at the vendor based upon the customer's second location;
g) adjusting the position of the order in the queue based upon the updated estimated time of arrival; and
h) completing the order at about the updated estimated time of arrival.

2. The method of claim 1, further comprising the step of:
displaying the queue to the vendor.

3. The method of claim 1, wherein the queue is arranged according to at least one of the following criteria: time of order, order start time, anticipated completion time of order, and/or customer's estimated time of arrival.

4. The method of claim 1, further comprising optionally repeating steps e), f) and g) until the order has been completed.

5. The method of claim 1, further comprising optionally repeating steps e), f) and g) until preparation of the order has been initiated.

6. The method of claim 1, wherein the customer's localization-capable device transmits the customer's location to the vendor, and the calculating of the estimated time of arrival is performed by a vendor central processing unit.

7. The method of claim 1, wherein the calculating of the estimated time of arrival is performed by the customer's localization-capable device, and the estimated time of arrival is transmitted to the vendor.

8. The method of claim 1, wherein the steps e), f) and g) are repeated at predetermined time intervals.

9. The method of claim 1, wherein the steps e), f) and g) are repeated continuously.

10. The method of claim 1, wherein the position of the order in the queue is adjusted only if the deviation of the updated estimated time of arrival from the original estimated time of arrival reaches a predetermined threshold.

11. The method of claim 1, further comprising the step of:
transmitting notification to the customer that preparation of the order has been initiated.

12. The method of claim 1, further comprising the steps of:
transmitting notification to the vendor that travel to the vendor's place of business will be delayed.

13. The method of claim 12, further comprising the step of:
transmitting notification to the vendor that travel to the vendor's place of business has resumed, thereby initiating steps b) to g).

14. The method of claim 1, further comprising the step of:
selecting a vendor location for pickup of the order.

15. The method of claim 1, further comprising the step of:
completing payment of the order by entering payment information into the customer's localization-capable device, and transmitting the payment information to the vendor or third party for processing.

16. A system for prioritizing a transmitted order based upon a customer's estimated time of arrival, the system comprising:
an order entry device for placing an order from a user;
a server for receiving and processing an order from the user; and
communication means between the order entry device and the server;
wherein the order entry device comprises self-localization capabilities for transmission of location and/or estimated time of arrival at a vendor.

17. The system according to claim 16, further comprising a graphical user interface for displaying a queue of pending orders.

18. The system according to claim 16, wherein the self-localization capabilities comprise a global positioning system.

19. The system according to claim 18, further comprising memory coupled to the order entry device, the memory having recorded thereon statements and instructions for execution by the order entry device, the statements and instructions comprising:
code means for transmitting an order to a vendor;
code means for identifying a location of the customer via the order entry device; and
code means for transmitting the location and/or the original estimated time of arrival of the customer to the server.

20. The system according to claim 19, wherein the memory coupled to the order entry device further comprises:
code means for identifying an updated location of the customer via the order entry device; and
code means for transmitting the updated location and/or an updated estimated time or arrival of the customer to the server.

21. The system according to claim 19, wherein the memory coupled to the order entry device further comprises:
code means for calculating the estimated time of arrival of the customer to the vendor based upon the customer's location.

22. The system according to claim 18, further comprising memory coupled to the server, the memory having recorded thereon statements and instructions for execution by the order entry device, the statements and instructions comprising:
code means for receiving and processing the order from the order entry device;
code means for receiving the location and/or the estimated time of arrival of the customer, and placing the order in a queue amongst other orders based upon an original estimated time of arrival;
code means for receiving an additional location and/or estimated time or arrival of the customer, and adjusting the position of the order in the queue based upon the updated estimated time of arrival.

23. The system according to claim 20, wherein the memory coupled to the server further comprises:
code means for calculating an estimated time of arrival of the customer at the vendor based upon the customer's location.
